(19) United States
(12) Patent Application Publication
(10) Pub. No.: US 2007/0200709 A1
(43) Pub. Date: Aug. 30, 2007

(54) Shoe with a child monitoring device

(76) Inventors: Ari Naim, Englewood, NJ (US); Gideon Naim, Ambler, PA (US)

Correspondence Address: Henry T. Brendzel, P.O. Box 574, Springfield, NJ, 07081, US

(21) Appl. No.: 11/709,011

(22) Filed: Feb. 21, 2007

Related U.S. Application Data
(60) Provisional application No. 60/775,502, filed on Feb. 22, 2006.

(51) Int. Cl. G08B 13/14

(52) U.S. Cl. 340/572.7; 340/572.8

(57) ABSTRACT

A shoe that includes an RFID tag that employs two antennas forming space diversity, and the signal developed at the two antennas develops time diversity.

### RELATED APPLICATION

This application is related to Provisional Application No. 60/775,502, filed Feb. 22, 2006.

### BACKGROUND OF THE INVENTION

This invention relates to a wearable with a child monitoring device, where in the context of this disclosure, a wearable is something that a person wears, such a clothing, a shoe, a hat, etc.

The proliferation of active RFID tagging has led to the introduction of RF based wireless personal monitoring systems both for kids and for valuables. Such systems typically comprise two parts: one part is the tag that attaches to the valuable or the child, and the other part is the monitor that goes with the person that is concerned about the whereabouts of the valuable or the child (caretaker). Normally, if the tag is separated from the monitor by more than a set distance, the monitor sounds an alarm (or vibrates).

One of the problems that make the adoption of such systems difficult is the attachment of the tag to the child. Almost all current attachment methods suffer one or another problem that hinder its use. A bracelet type of attachment is problematic because many children often pull on the bracelet until it finally gives up and breaks. Pin type attachments are usually self-restricted to girls, and anyway they present a challenge because it is hard to create a robust attachment means. Also, RF propagation is deteriorated when the tag is placed in tight proximity to the human body. Belt type attachments are not always convenient and they, too, suffer from body attenuation.

### SUMMARY OF THE INVENTION

An advance in the art is realized with an arrangement where a wearable, such as a shoe, a hat, etc. includes an embedded tag, and an embedded antenna, or a plurality of antennas. In one illustrative embodiment, a shoe includes a tag, with two antennas forming space diversity, or both space and time diversity.

### BRIEF DESCRIPTION OF THE DRAWINGS

FIG. 1 presents a tag with two antennas that provide both space and time diversity; and

FIGS. 2-3 depict a shoe with different arrangements of an embedded tag and associated antennas.

### DETAILED DESCRIPTION

A tag that is used in connection with this invention can be one that is constructed as disclosed in U.S. Pat. No. 7,061,429, issued Jun. 13, 2006. Briefly, during regular operation, the tag transmits short bursts to the monitor every few seconds. The monitor decides whether to trigger an alarm based on the tag's signal strength. One problem with this arrangement is that at times reflections from walls, floor and the surroundings cause destructive interference, and that reduces the signal strength (sometimes significantly), which can give rise to false alarms. The tag disclosed in the '429 patent includes a single antenna, but the design of this tag can be modified in accordance with the teachings in the field of space-time diversity, such as the teaching by Wittneben in “Base station modulation diversity for digital SIMULCAST,” Proc. IEEE VTC, pp. 505-511, May 1993, or the teaching by Seshadri and Winters in “Two Signaling Schemes For Improving The Error Performance Of Frequency-Division-Duplex (FDD) Transmission Systems Using Transmitter Antenna Diversity,” International Journal of Wireless Information Networks, Vol. 1, No. 1, 1994.

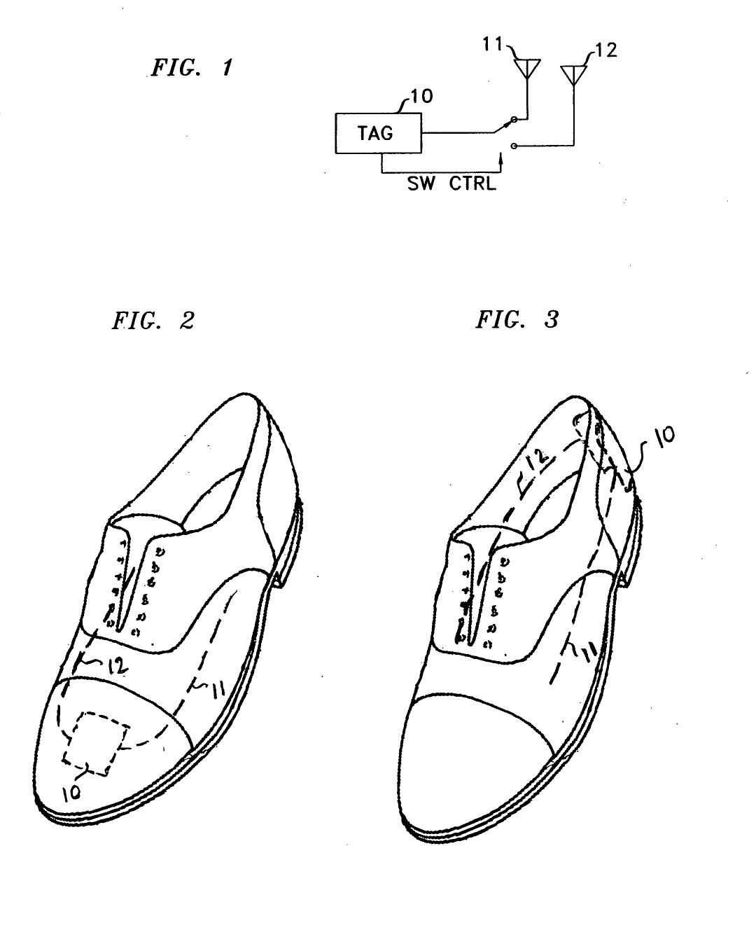

FIG. 1 presents a block diagram of an illustrative tag 10 that basically is as disclosed in the aforementioned '429 patent, except that it includes antennas 11 and 12, which are fed by a switch that distributes alternate signal bursts to each of the antennas. This reduces the effects for destructive interference of consecutive transmitted burst.

FIG. 2 depicts a first embodiment of a wearable in accord with the principles disclosed herein. It comprises a shoe, with tag 10 embedded in the top-front portion of the shoe, with antennas 11 and 12 also embedded in the shoe. Antennas 11 and 12 are embedded in the sides of the shoe, with one of the antennas running along the convex side of the shoe and the other of the antennas running along the concave side of the shoe.

The placement of tag 10 in the FIG. 2 shoe can be accomplished during manufacture of the shoe, which might easily achieve water tightness of tag 10. Alternatively, tag 10 may be purchased separately, and installed into the shoe by placing a tag (illustratively constructed to be water tight) in a pocket that is manufactured in the shoe for that purpose, where the packet includes end-point snap connector arrangement that couples the tag to the embedded antennas 11 and 12. Alternatively, the shoe contains sleeve-like cavities coupled to the pocket so that a tag can be inserted in the pocket concurrently with the placement of antennas that are permanently connected to the tag into the sleeves.

FIG. 3 depicts a second embodiment where tag 10 is embedded in the back of the shoe and antennas 11 and 12 run from the tag, also along the convex and concave sides of the shoe, respectively.

In another embodiment, both shoes of a pair shoes contain a tag that employs one, or two, antennas; where the physical construction of the shoe-tag combination being the same as shown in FIGS. 2-3, but the tags operate in synchronism with each other. In one arrangement the tags include receivers, and the two tags are synchronized by the monitor which directs them when to transmit. Specifically, the monitor directs only one tag to transmit at any one time. In another embodiment the tags do not include a receiver and the tags either transmit with constant but different duty cycles (that are not a multiple of one another), or transmit with a random duty cycle. In these arrangements, a collision between the transmissions of the two tags is possible, but having two collisions in a row is not possible (in the constant duty cycle arrangement) or highly unlikely (in the random duty cycle arrangement). It should be realized, however, that with the unsynchronized operations described above an alarm should be sounded only on the occurrence of more than one miss of a burst reception. In order to reduce the time required to alarm, the average burst transmission rate needs to double.

Although the illustrative embodiments disclosed above use two antennas, it should be realized that a single antenna could also be employed. Further, the antenna or antennas can be embedded in something that is only a part of the shoe and not the shoe itself, such as embedded in a loop at the top of the back of the shoe (already found in some children shoes nowadays), or in the laces. Also the tags do not need to be truly embedded in the shoe. They can be arranged to be inserted into sleeve or pockets in the shoe, as described above, or simply attached to the shoe in a relatively permanent manner.

1. Apparatus comprising:
a shoe,
an RFID tag physically coupled to the wearable; and
a first antenna running along a first side of the shoe, and a second antenna running along a second side of the shoe.

2. The apparatus of claim 4 where the RFID tag includes circuitry for sending signal different bursts to the first and the second antennas that create a space-time diversity in the transmission of signals by the RFID.

3. The apparatus of claim 2 where the circuitry includes a switch that sends alternate signal bursts to the antennas of the pair of antennas.

4. The apparatus of claim 1 where the RFID tag is embedded in the shoe during manufacture.

5. The apparatus of claim 1 where the shoe includes a means for attaching the RFID tag to the shoe.

6. The apparatus of claim 5 where the means for attaching is a pocket.

7. The apparatus of claim 1 where the shoe includes a pocket for accepting the RFID tag and two sleeves for accepting a pair of antennas.

8. The apparatus of claim 1 where the RFID is water tight.
